(19) United States
(12) Patent Application Publication
(10) Pub. No.: US 2025/0281891 A1
(43) Pub. Date: Sep. 11, 2025

(54) SEPARATION AND PURIFICATION MODULE AND AUTOMATED MATERIAL REACTION SYSTEM INCLUDING THE SAME

(71) Applicant: SAMSUNG ELECTRONICS CO., LTD., Suwon-si (KR)

(72) Inventors: Hyun Do CHOI, Suwon-si (KR); Jeonghun KIM, Suwon-si (KR); Hyunjeong JEON, Suwon-si (KR); Taesin HA, Suwon-si (KR); Youngchun KWON, Suwon-si (KR); Hyukju KWON, Suwon-si (KR); Bosung KIM, Suwon-si (KR); Jin Woo KIM, Suwon-si (KR); Dongseon LEE, Suwon-si (KR); Sangyoon LEE, Suwon-si (KR); Minsu CHANG, Suwon-si (KR); Jaejun CHANG, Suwon-si (KR); Jaehyung JANG, Suwon-si (KR); Jun-Won JANG, Suwon-si (KR); Joon-Kee CHO, Suwon-si (KR); Byung-Kwon CHOI, Suwon-si (KR); Won Je CHOI, Suwon-si (KR); Wooram HONG, Suwon-si (KR)

(73) Assignee: SAMSUNG ELECTRONICS CO., LTD., Suwon-si (KR)

(21) Appl. No.: 19/068,604

(22) Filed: Mar. 3, 2025

(30) Foreign Application Priority Data
Mar. 7, 2024 (KR) 10-2024-0032764

(51) Int. Cl. B01J 4/02; B01J 4/00; B01J 19/00

(52) U.S. Cl. CPC B01J 4/02; B01J 4/008; B01J 19/0006; B01J 2219/00423

(57) ABSTRACT

An automated material reaction system includes a material storage, which stores store at least one material, a dispensing module, which dispenses, to a reaction container, the at least one material stored in the material storage, a reaction module, which causes a reaction of the at least one material dispensed to the reaction container, a purification module, which extracts a target product from a product produced by the reaction module and purifies the target product, and a transport device, which transports the target product to the dispensing module such that the target product is used as a reactant.

### CROSS-REFERENCE TO RELATED APPLICATION

This application is based on and claims priority from Korean Patent Application No. 10-2024-0032764, filed on Mar. 7, 2024, in the Korean Intellectual Property Office, the disclosure of which is incorporated by reference herein in its entirety.

### BACKGROUND

### 1. Field

The disclosure relates to a separation and purification module and an automated material reaction system including the separation and purification module.

### 2. Description of the Related Art

Research is being conducted on systems that automatically perform organic synthesis based on flow chemistry. However, in related art systems, user intervention was inevitably required in some parts of the synthesis recipe generation process to implement automation. In other words, in related art systems, user intervention was inevitable, limiting the capability of the system for developing materials in multiple steps. Therefore, there is a demand for an automated material reaction system in which the entire process may be performed automatically, allowing materials to react in multiple steps.

### SUMMARY

One or more embodiments may address at least the problems and/or disadvantages described above, and other disadvantages not described above. Also, the embodiments are not required to overcome and may not overcome any of the problems and disadvantages described above.

According to an aspect of the disclosure, there is provided an automated material reaction system including: a material storage configured to store at least one material; a dispensing module configured to dispense, to a reaction container, the at least one material stored in the material storage; a reaction module configured to output a first product based on a reaction based on the at least one material dispensed to the reaction container; a separation and purification module configured to: extract a second product from the product output by the reaction module, and purify the second product; and a transport device configured to transport the second product to the dispensing module to be input as a reactant.

The transport device may be further configured to automatically transfer a material to be transferred between the material storage, the dispensing module, the reaction module, and the separation and purification module.

The separation and purification module may include: a work-up module configured to separate the second product from the first product output by the reaction module; and a purification module configured to purify the second product from a processing material of the work-up module.

The work-up module may include a filter or an evaporator.

The work-up module may further include a solvent supplier configured to supply a solvent to the filter or the evaporator.

The purification module may include: a liquid chromatography device configured to separate the second product from the processing material processed of the work-up module; and a fraction collector configured to fractionize the second product separated by the liquid chromatography device.

The purification module may further include an evaporator configured to vaporize a solvent from the second product fractionized by the fraction collector.

The purification module may further include a weighing machine configured to measure a weight of the second product processed by the evaporator.

The purification module may further include a solvent supplier configured to supply a solvent to the evaporator, and the purification module may be further configured to supply the material processed by the evaporator back to the liquid chromatography device.

Each of the work-up module and the purification module may include a capper configured to attach a cap to a container or remove the cap from the container.

A material in the work-up module and the purification module may be automatically transported by a sub-transport device.

The automated material reaction system may include a product storage configured to store the second product.

The automated material reaction system may include an analysis module configured to analyze the second product.

The automated material reaction system may include a preprocessing module configured to preprocess the second product produced by the reaction module.

The automated material reaction system may include an artificial intelligence device configured to control the automated material reaction system to operation in an automated manner.

According to an aspect of the disclosure, there is provided a separation and purification module applied to an automated material reaction system, the separation and purification module including: a work-up module configured to separate, from a first product, a second product produced by a reaction module; and a purification module configured to purify the second product from a processing material of the work-up module, wherein the work-up module includes a filter or a first evaporator, and wherein the purification module includes a liquid chromatography device and a fraction collector.

The purification module further may include: a second evaporator configured to vaporize a first solvent from the second product fractionized by the fraction collector; and a solvent supplier configured to supply a second solvent the second product processed by the evaporator, wherein the purification module is further configured to supply the second product back to the liquid chromatography device.

The purification module may further include a weighing machine configured to measure a weight of the second product processed by the evaporator.

Each of the work-up module and the purification module may further include a capper configured to attach or remove a cap to or from a container.

A material in the work-up module and the purification module may be automatically transported by a sub-transport device.

### BRIEF DESCRIPTION OF DRAWINGS

The above and/or other aspects will be more apparent from descriptions of certain embodiments referring to the accompanying drawings, in which:

FIG. 1 is a block diagram schematically illustrating an automated material reaction system according to an embodiment;

FIG. 2 is a block diagram schematically illustrating a separation and purification module according to an embodiment;

FIG. 3 is a flowchart of a purification process according to an embodiment;

FIG. 4 is a flowchart of a purification process according to an embodiment;

FIG. 5 is a block diagram of an operation of an automated material reaction system, according to an embodiment;

FIG. 6 is a block diagram illustrating processes of a single-step reaction optimization platform and a scale-up purification platform, according to an embodiment;

FIG. 7 is a flowchart of a scale-up purification process according to an embodiment; and

FIG. 8 is a flowchart of an operation of an automated material reaction system according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, components, or groups thereof but do not preclude the presence or addition of one or more other features, integers, steps, operations, elements, components, or groups thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the disclosure, and are not to be interpreted in an idealized or overly formal sense unless expressly so defined herein.

Furthermore, when describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the disclosure.

In addition, terms such as first, second, A, B, (a), (b), and the like may be used to describe components of the examples. These terms are used only for the purpose of discriminating one component from another component, and the nature, the sequences, or the orders of the components are not limited by the terms. When one component is described as being “connected,” “coupled,” or “attached” to another component, it should be understood that one component may be connected or attached directly to another component, and an intervening component may also be “connected,” “coupled,” or “attached” to the components.

The same name may be used to describe an element included in the embodiments described above and an element having a common function. Unless otherwise mentioned, the description on one embodiment may be applicable to other embodiments and thus, duplicated descriptions will be omitted for conciseness.

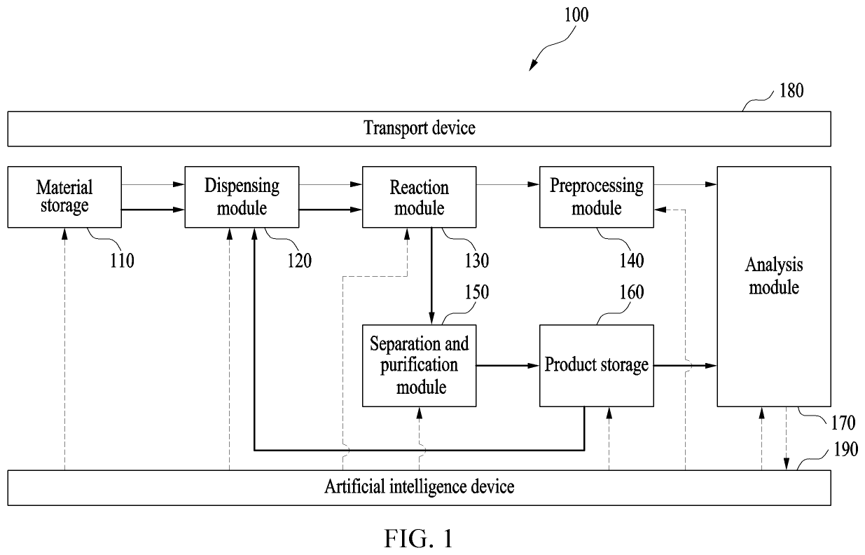

FIG. 1 is a block diagram schematically illustrating an automated material reaction system according to an embodiment.

Referring to FIG. 1, according to an embodiment, an automated material reaction system 100 may be configured to automatically perform a process of causing a reaction of a material. For example, the automated material reaction system 100 may be configured to automatically perform multi-step reactions. For example, the automated material reaction system 100 may be configured to automatically perform consecutive multi-step reactions. For example, the automated material reaction system 100 may be configured to perform a first reaction such that a product resulting from the first reaction is used as a reactant of a second reaction. For example, the automated material reaction system 100 may be configured to perform the first reaction and then scale up and/or purify the product resulting from the first reaction such that the product may be used as a reactant of the second reaction. For example, the entire process of the automated material reaction system 100 may be automated, requiring no user intervention. For example, the automated material reaction system 100 may be automated and operated by artificial intelligence (e.g., an artificial intelligence device 190). For example, the automated material reaction system 100 may autonomously synthesize predetermined materials to optimize a corresponding reaction recipe. For example, the automated material reaction system 100 may use the optimized reaction recipe to perform a scale-up reaction and obtain a target material through a separation and purification process. For example, the automated material reaction system 100 may automatically perform a process of inputting the material obtained through scale-up as a source of the subsequent reaction. Each process of the automated material reaction system 100 may be performed repeatedly and/or autonomously. For example, the automated material reaction system 100 may be utilized in the material development field and/or pharmaceutical field and may contribute to lab automation. For example, the automated material reaction system 100 may automatically perform organic synthesis based on flow chemistry. For example, the automated material reaction system 100 utilizing artificial intelligence technology may be used to autonomously improve an organic synthesis method or suggest a new organic synthesis method.

In an embodiment, the automated material reaction system 100 may include a material storage 110, a dispensing module 120, a reaction module 130, a preprocessing module 140, a separation and purification module 150, a product storage 160, an analysis module 170, a transport device 180, and/or the artificial intelligence device 190. However, these are only examples, and components of the automated material reaction system 100 are not limited thereto. As such, one or more components may be added and/or removed from the automated material reaction system 100. According to an embodiment, the automated material reaction system 100 may include a controller or a control circuit. In some embodiments, the controller or the control circuit may be may be provided in the components or modules of the automated material reaction system 100.

For example, the controller may be a memory and a processor. For example, the memory as a storage for storing data may store, for example, various algorithms, various programs, and various data. The memory may store one or more instructions. The memory may include at least one of volatile memory and non-volatile memory. The non-volatile memory may include read only memory (ROM), programmable ROM (PROM), electrically programmable ROM (EPROM), electrically erasable and programmable ROM (EEPROM), flash memory, phase-change random access memory (PRAM), magnetic RAM (MRAM), or resistive RAM (RRAM). The volatile memory may include dynamic RAM (DRAM), static RAM (SRAM), synchronous DRAM (SDRAM), PRAM, MRAM, or RRAM. In an embodiment, the memory may include at least one of a hard disk drive (HDD), a solid state drive (SSD), compact flash (CF), secure digital (SD), micro-SD, mini-SD, extreme digital (xD), and a memory stick. In an embodiment, the memory 1100 may semi-permanently or temporarily store algorithms, programs, and one or more instructions executed by the processor.

The processor may control an overall operation of the automated material reaction system 100. The processor may include one or more of a central processing unit (CPU), an application processor (AP), and a communication processor (CP). The processor may perform, for example, an operation or processing related to control and/or communication of at least one other component of the automated material reaction system 100. For example, the processor may execute one or more instructions corresponding to one or more of the various algorithms, various programs.

In an embodiment, the material storage 110 may be a component for storing at least one material. A material stored in the material storage 110 may be a predetermined material used for a chemical reaction. For example, the material stored in the material storage 110 may include a reactant, a solvent, and/or a catalyst. The reactant may be a sample and/or a reagent. However, the material stored in the material storage 110 is not limited thereto. The material storage 110 may provide a designated environment for storing the material. For example, the material storage 110 may include a pantry, a refrigerator, a warmer, and/or a vacuum chamber. However, these are only examples, and the type of the material storage 110 is not limited thereto.

In an embodiment, the dispensing module 120 may be a component for dispensing at least one material stored in the material storage 110 to a reaction container. For example, the dispensing module 120 may include a module for dispensing a liquid material and/or a module for dispensing a solid material. For example, the dispensing module 120 may dispense a designated material to a designated container with a designated volume or weight according to an input command. For example, the dispensing module 120 may include a capper for attaching a cap to a container or removing the cap from the container. For example, the dispensing module 120 may include a robot arm for gripping and/or transporting the container. For example, the dispensing module 120 may include a device for measuring the volume or weight of the material. However, this is only an example, and the function and/or components of the dispensing module 120 are not limited thereto.

In an embodiment, the reaction module 130 may be a component for causing a reaction of at least one material dispensed to a reaction container. For example, the reaction module 130 may be configured to provide an environment required for a chemical reaction to occur. For example, the reaction module 130 may include a reaction room for providing a designated reaction condition. For example, the designated reaction condition may include, but is not limited to, temperature, pressure, and/or humidity, etc. For example, the reaction module 130 may include a mixer or a stirrer that may consistently mix a material. However, this is only an example, and the function and/or components of the reaction module 130 are not limited thereto.

In an embodiment, the preprocessing module 140 may be a component for preprocessing a product produced in the reaction module 130. For example, the preprocessing module 140 may be a component for preprocessing a material before analyzing the material. For example, the preprocessing module 140 may undergo a process of purifying, cleaning, separating, concentrating, diluting, and/or extracting a material. However, this is only an example, and the function of the preprocessing module 140 is not limited thereto.

In an embodiment, the separation and purification module 150 may be a component for extracting a target product from a product produced by the reaction module 130 and purifying the target product. For example, the separation and purification module 150 may be configured to extract a target product or a target component from a mixture produced after the chemical reaction. For example, the separation and purification module 150 may be configured to extract only a target product from a product produced after a chemical reaction and increase purity. The separation and purification module 150 is described in detail below.

In an embodiment, the product storage 160 may be a component for storing a product (e.g., a target product). A material stored in the product storage 160 may be an intermediate product or a final product. However, a material stored in the product storage 160 is not limited thereto. The product storage 160 may provide a designated environment for storing the material. For example, the product storage 160 may provide a designated environment for storing the target product extracted by the separation and purification module 150. For example, the product storage 160 may include a pantry, a refrigerator, a warmer, and/or a vacuum chamber. However, these are only examples, and the type of the product storage 160 is not limited thereto. For example, the product storage 160 may include a robot arm, a capper, and/or a pipette device. For example, the product storage 160 may include components configured to operate autonomously.

In an embodiment, the analysis module 170 may be a component for analyzing a product (e.g., a target product). For example, the analysis module 170 may perform liquid chromatography-mass spectrometry (LC-MS), ultraviolet-visible photoluminescence (UV-PL), and/or nuclear magnetic resonance (NMR) analyses. For example, the analysis module 170 may include a liquid chromatography device, a mass spectrometry device, an infrared-visible light spectroscopic device, and/or a nuclear magnetic resonance spectroscopic device. However, these are only examples, and the type of the analysis module 170 is not limited thereto.

In an embodiment, the transport device 180 may be a component for transporting a material and/or a container in the automated material reaction system 100. For example, the transport device 180 may be a component for transporting a material and/or a container between and/or within each module. For example, the transport device 180 may transport a material and/or a container between the material storage 110, the dispensing module 120, the reaction module 130, the preprocessing module 140, the separation and purification module 150, the product storage 160, and the analysis module 170. For example, the transport device 180 may transport a material and/or a container within each of the product storage 110, the dispensing module 120, the reaction module 130, the preprocessing module 140, the separation and purification module 150, the product storage 160, and the analysis module 170. For example, the transport device 180 may include a robot arm, a picker, a gripper, and/or a transport rail. However, these are only examples, and the function and/or components of the transport device 180 are not limited thereto. For example, the transport of a material and/or a container not elaborated in this disclosure is understood to be performed by the transport device 180.

In an embodiment, the artificial intelligence device 190 may be an artificial intelligence-based device. For example, the artificial intelligence device 190 may be a processor and/or a memory that may use artificial intelligence. For example, the processor may be a neural network processor. The neural network processor may generate a neural network model, may train or learn the neural network model, may perform an operation based on received input data, may generate an information signal based on the operation result, or may retrain or update the neural network model. The neural network processor may process an operation based on various types of networks such as a convolution neural network (CNN), a region with a convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), restricted Boltzman machine (RBM), a fully convolutional network, a long short-term memory (LSTM) network, and a classification network. However, the disclosure is not limited thereto, and various types of computational processing that simulates human neural networks may be performed. The neural network processor may be implemented as a neural network operation accelerator, a coprocessor, a digital signal processor (DSP), an application specific integrated circuit (ASIC), a field-programmable gate array (FPGA), a graphics processing unit (GPU), a neural processing unit (NPU), a tensor processing unit (TPU), or a multi-processor system-on-chip (MPSoC). The neural network processor may include one or more processors to perform operations according to neural network models. In addition, the neural network processor may include separate memory for storing programs corresponding to the neural network models. The neural network processor may be referred to as a neural network processing device, a neural network integrated circuit, or a neural network processing unit (NPU).

The artificial intelligence device 190 may autonomously drive the automated material reaction system 100 using artificial intelligence. For example, procedures performed by the artificial intelligence device 190 are presented by dashed lines in FIG. 1. For example, the artificial intelligence device 190 may receive an analysis result (e.g., the yield and/or purity of a product and/or a by-product) from the analysis module 170. The artificial intelligence device 190 may use the analysis result to control the material storage 110, the dispensing module 120, the reaction module 130, the preprocessing module 140, the separation and purification module 150, the product storage 160, and/or the analysis module 170. For example, the artificial intelligence device 190 may use the analysis result to adjust the type of material (e.g., a reagent) discharged from the material storage 110. For example, the artificial intelligence device 190 may use the analysis result to adjust a dispensing condition and/or method of the dispensing module 120. For example, the artificial intelligence device 190 may use the analysis result to adjust reagent dispensing volume and the like. For example, the artificial intelligence device 190 may use the analysis result to adjust a reaction condition and/or method of the reaction module 130. For example, the artificial intelligence device 190 may use the analysis result to adjust the reaction temperature, pressure, time, and/or humidity of the reaction module 130. For example, the artificial intelligence device 190 may use the analysis result to adjust a preprocessing condition and/or method of the preprocessing module 140. For example, the artificial intelligence device 190 may use the analysis result to adjust a separation and purification condition and/or method of the separation and purification module 150. For example, the artificial intelligence device 190 may use the analysis result to optimize a purification method. For example, the analysis result may include, but is not limited to, final purity, material evaluation result after purification, and/or purification method evaluation result. For example, the artificial intelligence device 190 may optimize the purification method by repeatedly performing a process of modifying the purification method and analyzing and evaluating the purification result obtained through the modified purification method. For example, the artificial intelligence device 190 may enable purification to be performed with the optimized purification method in the separation and purification module 150. For example, the artificial intelligence device 190 may adjust a condition and/or a method of storing and/or processing a material stored in the material storage 160. For example, the artificial intelligence device 190 may adjust the analysis conditions and/or methods performed by the analysis module 170. However, this is only an example, and the function of the artificial intelligence device 190 is not limited thereto.

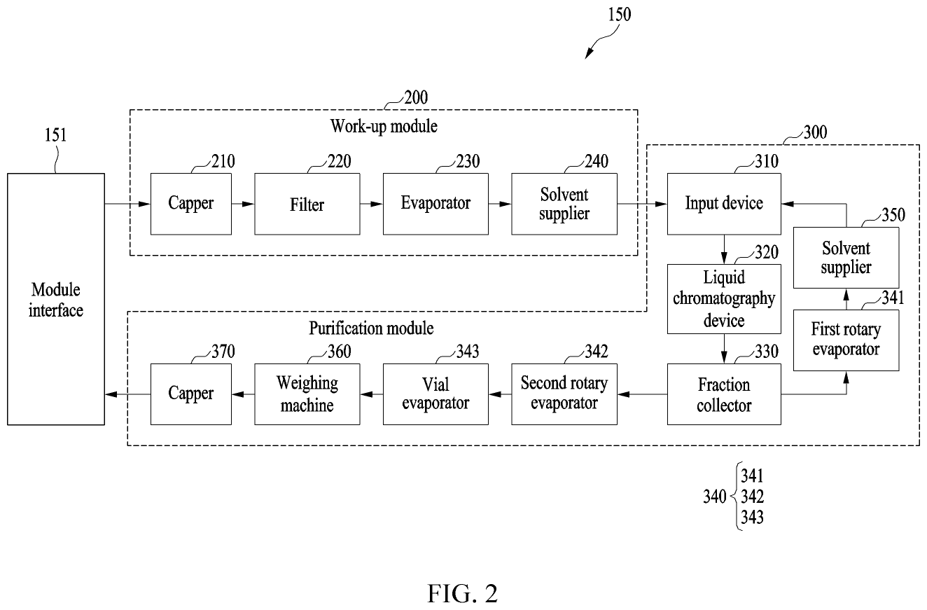

FIG. 2 is a block diagram schematically illustrating a separation and purification module according to an embodiment.

Referring to FIG. 2, according to an embodiment, the separation and purification module 150 may include a module interface 151, a work-up module 200, and/or a purification module 300. However, these are only examples, and components of the separation and purification module 150 are not limited thereto. As such, one or more components may be added and/or removed from the separation and purification module 150.

In an embodiment, the module interface 151 may be a part in which the separation and purification module 150 interacts with another module. For example, the module interface 151 may receive a material from a transport device (e.g., the transport device 180 of FIG. 1) or transfer a material to the transport device (e.g., the transport device 180 of FIG. 1). For example, in the module interface 151, a material may be transported from the transport device (e.g., the transport device 180 of FIG. 1) to the work-up module 200. For example, in the module interface 151, a material may be transported from the purification module 300 to the transport device (e.g., the transport device 180 of FIG. 1).

In an embodiment, the work-up module 200 may be a component for separating a target product from a product or a result produced by a reaction module (e.g., the reaction module 130 of FIG. 1). The work-up module 200 may include a capper 210, a filter 220, an evaporator 230, and/or a solvent supplier 240. However, these are only examples, and components of the work-up module 200 are not limited thereto.

In an embodiment, the capper 210 may be a component for attaching a cap to a container or removing the cap from the container. For example, the capper 210 may separate a cap from a container transported to the work-up module 200. For example, in a case in which the cap is separated by the capper 210, dilution may quench a reaction. The container, with the cap removed, may be transported to the filter 220.

In an embodiment, the filter 220 may be a component for filtering a target material to separate the target material from a transported material. For example, the filter 220 may include various filter cartridges. For example, the filter 220 may eliminate a catalyst, water, and/or inorganic matter from the transported material. However, this is only an example, and the material filtered by the filter 220 is not limited thereto. The material processed by the filter 220 may be transported to the evaporator 230.

In an embodiment, the evaporator 230 may be a component for eliminating a solvent from a material. For example, the evaporator 230 may eliminate the entire solvent by vaporizing the solvent from the transported material. For example, the evaporator 230 may be a rotary evaporator. However, this is only an example, the type of the evaporator 230 is not limited thereto. The material processed by the evaporator 230 may be transported to the solvent supplier 240.

In an embodiment, the solvent supplier 240 may supply a solvent to the material processed by the filter 220 and/or the evaporator 230. For example, the solvent supplier 240 may supply a material with a new solvent of a known concentration. The supplied solvent may be mixed with the material by a sonicator and/or a shaker. For example, the solver supplier 240 may receive a resulting material from the evaporator 230 and mix the new solvent with the mixture. The material processed by the solvent supplier 240 may be transported to the purification module 300 (e.g., an input device 310 of the purification module 300).

In an embodiment, the purification module 300 may be a component for purifying the target product from the material processed by the work-up module 200. The purification module 300 may include the input device 310, a liquid chromatography device 320, a fraction collector 330, an evaporator 340, a solvent supplier 350, a weighing machine 360, and/or a capper 370. However, these are only examples, and components of the purification module 300 are not limited thereto.

In an embodiment, the input device 310 may be a component for inputting a material to the liquid chromatography device 320. For example, the input device 310 may input the material received from the work-up module 200 into the liquid chromatography device 320. For example, the input device 310 may perform a cleaning operation on the material received from the work-up module 200 to prevent cross-contamination before the material is input into the liquid chromatography device 320.

In an embodiment, the liquid chromatography device 320 may be a component for performing liquid chromatography. For example, the liquid chromatography device 320 may separate the target product from the material processed by the work-up module 200. For example, the liquid chromatography device 320 may separate a material by following a designated protocol.

In an embodiment, the fraction collector 330 may be a component for dividing the material separated from the liquid chromatography device 320. For example, the material separated from the liquid chromatography device 320 may be subsequently fractionized by the fraction collector 330.

In an embodiment, the evaporator 340 may be a component for vaporizing a solvent from the material fractionized by the fraction collector 330. For example, the evaporator 340 may include a first rotary evaporator 341, a second rotary evaporator 342, and/or a vial evaporator 343.

In an embodiment, the first rotary evaporator 341 may be a component for eliminating a solvent from the fractionized material. For example, the first rotary evaporator 341 may eliminate the entire solvent from the material by vaporizing the solvent from the fractionized material. The material processed by the first rotary evaporator 341 may be transported to the solvent supplier 350.

In an embodiment, the solvent supplier 350 may be a component for supplying a solvent to the material processed by the first rotary evaporator 341 to supply the material processed by the first rotary evaporator 341 back to the liquid chromatography device 320. For example, the solvent supplier 350 may supply the material with a new solvent of a known concentration. For example, the new solvent may be same or different from the solvent supplied by the solvent supplier of the work-up module 240. The supplied solvent may be mixed with the material by a sonicator and/or a shaker. The first rotary evaporator 341 and the solvent supplier 350 may be components for recycling preprocessing. The material processed by the solvent supplier 350 may be transported to the input device 310 and then supplied back to the liquid chromatography device 320. According to an embodiment, the process in which the material processed by the solvent supplier 350 may be transported back to the input device 310 and then supplied back to the liquid chromatography device 320 may be repeated a designated number of times.

In an embodiment, the second rotary evaporator 342 may be a component for eliminating the solvent from the fractionized material. For example, the second rotary evaporator 342 may eliminate the entire solvent from the material by vaporizing the solvent from the fractionized material. The material processed by the second rotary evaporator 342 may be transported to the vial evaporator 343. According to an embodiment, the first rotary evaporator 341 and the second rotary evaporator 342 may have the same components.

In an embodiment, the vial evaporator 343 may be a component for inputting the material transported from the second rotary evaporator 342 into a vial and eliminating the solvent. For example, in the vial evaporator 343, a designated amount of solvent may be input into an evaporating container to dilute and dissolve the material. The vial evaporator 343 may vaporize the entire solvent. The material processed by the vial evaporator 343 may be transported to the weighing machine 360.

In an embodiment, the weighing machine 360 may be a component for measuring the weight of a material processed by an evaporator (e.g., the vial evaporator 343). For example, the weighing machine 360 may measure the weight of a vial to measure the amount of the obtained material.

In an embodiment, the capper 370 may be a component for attaching or removing a cap to or from a container. For example, the capper 370 may couple a cap to a container transported from the weighing machine 360. The container with the cap closed may be transported to the module interface 151 and then transported to a product storage (e.g., the product storage 160 of FIG. 1), a dispensing module (e.g., the dispensing module 120 of FIG. 1), and/or an analysis module (e.g., the analysis module 170 of FIG. 1).

In an embodiment, the separation and purification module 150 may be configured such that each process of the separation and purification module 150 is automatically performed. For example, a material may be automatically transported in the work-up module 200 and/or the purification module 300 by a sub-transport device. For example, the sub-transport device may include a robot arm, a picker, a gripper, and/or a transport rail. The separation and purification module 150 may be automated and operated by artificial intelligence (e.g., the artificial intelligence device 190). For example, the entire process of the separation and purification module 150 may be automated without a user's intervention such that the separation and purification module 150 autonomously separates and/or purifies a predetermined material.

Referring to FIG. 1, in an embodiment, in the automated material reaction system 100, a single reaction procedure and/or a multi-step reaction procedure may be performed.

Hereinafter, a single reaction procedure is described with reference to FIG. 1. Referring to FIG. 1, the single reaction procedure is represented by thin lines. In the single reaction procedure, at least one material stored in the material storage 110 may be dispensed to a reaction container (e.g., a vial) by the dispensing module 120, and a chemical reaction may be performed by the reaction module 130. A product produced by the reaction module 130 may be preprocessed by the preprocessing module 140 and then analyzed by the analysis module 170. The preprocessing operation may include, but is not limited to, diluting or filtering the product produced by the reaction module 130. For example, the analysis module 170 may detect a reaction status through liquid chromatography-mass spectrometry. For example, the analysis module 170 may analyze the amount of molecules, retention time, yield, and the presence or absence of a by-product and/or a starting material. For example, the analysis module 170 may infer a produced material from an analysis result. For example, while a reaction occurs in the reaction module 130, a product may be periodically sampled such that the preprocessing and analysis described above are performed. However, this is only an example, and the single reaction procedure is not limited thereto.

Hereinafter, a multi-step reaction procedure is described with reference to FIG. 1. The multi-step reaction procedure may be a procedure for maximizing yield or optimizing a reaction by repeatedly performing a single reaction procedure a plurality of times. Referring to FIG. 1, the multi-step reaction procedure is represented by thick lines. In the multi-step reaction procedure, at least one material stored in the material storage 110 may be dispensed to a container (e.g., a vial) by the dispensing module 120, and a chemical reaction may be performed by the reaction module 130. The separation and purification module 150 may extract a target product from a product produced by the reaction module 130 and purify the target product. In an example, extracting the target product from the product produced by the reaction module 130 may including extracting a target component from a mixture of components in a result produced by the reaction module 130. For example, the separation and purification module 150 may separate water, a catalyst, and/or inorganic matter from the product and separate a solute dissolved in a solvent through liquid chromatography. The target product, which is the result of the separation and purification module 150, may be contained in a container (e.g., an intermediate vial) and stored in the product storage 160. The transport device 180 may transport the target product to the dispensing module 120 such that the target product stored in the product storage 160 is used again as a reactant. For example, the product storage 160 may dispense the target product to a new container through pipetting, and the transport device 180 may transport the new container containing the target product to the dispensing module 120. The dispensing module 120 may additionally dispense other materials to the container, as necessary. According to an embodiment, a chemical reaction for a subsequent step may be performed by the reaction module 130, and the process described above may be consecutively and automatically repeated until the target product is obtained. The final target product may be transported to and stored in the product storage 160. While the process described above is repeatedly performed, a target product at each step may be analyzed by the analysis module 170. For example, the analysis module 170 may detect a reaction status through liquid chromatography-mass spectrometry. For example, the analysis module 170 may analyze the number of molecules, retention time, yield, and the presence or absence of a by-product, a starting material, and/or a final target product. For example, the analysis module 170 may infer a produced material from an analysis result. However, this is only an example, the multi-step reaction procedure is not limited thereto. For example, the target product separated and purified by the separation and purification module 150 may be transported direct to the dispensing module 120 and/or the analysis module 170 by the transported device 180 without passing through the product storage 160. The multi-step reaction procedure described above may be autonomously performed by artificial intelligence (e.g., the artificial intelligence device 190). With this structure, a multi-step reaction may be fully automated and implemented without user intervention.

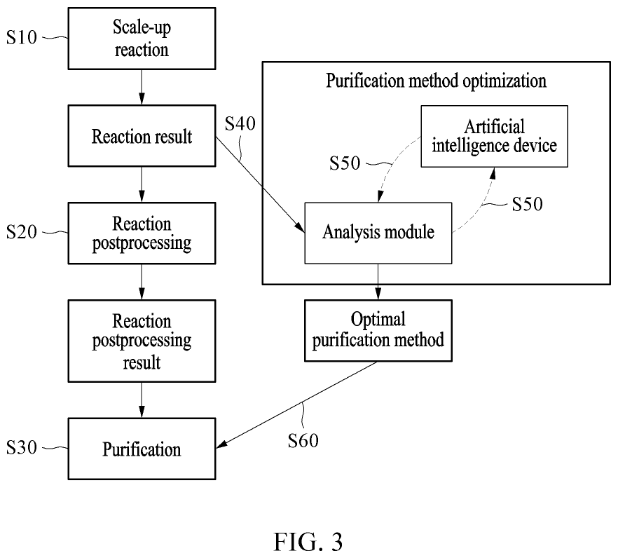

FIG. 3 is a flowchart of a purification process according to an embodiment. As illustrated in FIG. 3, a procedure performed by artificial intelligence is represented by dashed lines.

In an embodiment, the purification process as illustrated in FIG. 3 may be performed by the automated material reaction system 100 of FIG. 1. Referring to FIGS. 1, 2, and 3, a scale-up reaction may be performed by the reaction module 130 (S10). The result of the scale-up reaction may be transported to the purification module 150 (S20), and a reaction postprocessing process may be performed by the separation and purification module 150. For example, the reaction postprocessing process may include a purification preprocessing process. The result of the reaction postprocessing process may be transported to the separation and purification module 150 and purified by the separation and purification module 150 (S30). In addition, the result of the scale-up reaction may be transported to the analysis module 170 and analyzed (S40). The artificial intelligence device 190 may optimize a purification method based on the analysis result of the analysis module 170. For example, the artificial intelligence device 190 may optimize the purification method by repeatedly performing a process of modifying the purification method and analyzing and evaluating the purification result obtained through the modified purification method (S50). In the separation and purification module 150, a separation and purification process may be performed using the optimized purification method (S60).

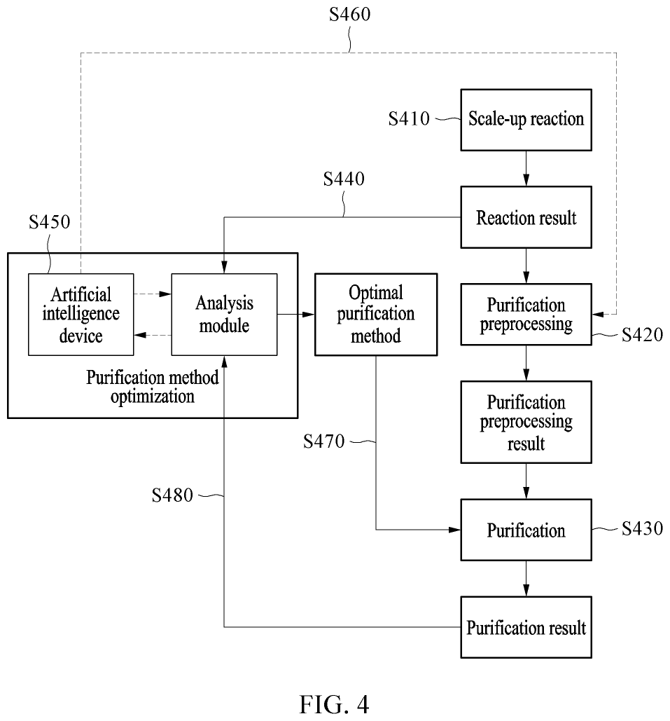

FIG. 4 is a flowchart of a purification process according to an embodiment. As illustrated in FIG. 4, a procedure performed by artificial intelligence is represented by dashed lines.

In an embodiment, the purification process as illustrated in FIG. 4 may be performed by the automated material reaction system 100 of FIG. 1. Referring to FIGS. 1, 2, and 3, a scale-up reaction may be performed by the reaction module 130 (S410). The result of the scale-up reaction may be transported to the separation and purification module 150, and a purification preprocessing process may be performed by the separation and purification module 150 (S420). For example, the purification preprocessing process may be performed by the work-up module 200. The result of the purification preprocessing process may be purified by the purification module 300 (S430). In addition, the result of the scale-up reaction may be transported to and analyzed by the analysis module 170 (S440). The artificial intelligence device 190 may optimize a purification method and/or the purification preprocessing process based on the analysis result of the analysis module 170 (S450). For example, the purification preprocessing process may be based on output from the artificial intelligence device (S460). For example, the artificial intelligence device 190 may optimize the purification method by repeatedly performing a process of modifying the purification method and analyzing and evaluating the purification result obtained through the modified purification method (S470). In the purification module 300, a purification process may be performed using the optimized purification method. In an embodiment, the purification result from the purification module 300 may be transported to and analyzed by the analysis module 170 (S480).

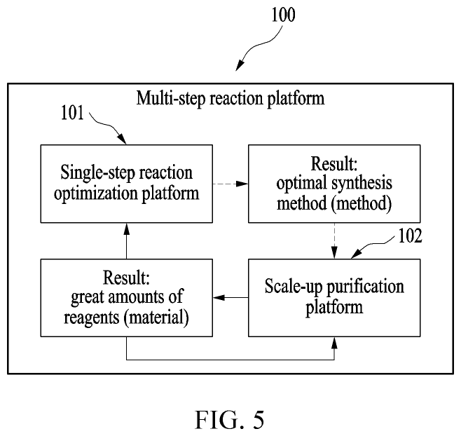

FIG. 5 is a block diagram of an operation of an automated material reaction system, according to an embodiment. As illustrated in FIG. 5, a procedure performed by artificial intelligence is represented by a dashed line.

Referring to FIGS. 1, 2, and 5, in an embodiment, the automated material reaction system 100 may be utilized as a platform for developing a material. For example, the automated material reaction system 100 may be utilized as a multi-step reaction platform. For example, the automated material reaction system 100 may include a single-step reaction optimization platform 101 and a scale-up purification platform 102. The single-step reaction optimization platform 101 may be a platform for optimizing a single-step reaction. For example, the single-step reaction optimization platform 101 may be a platform for performing the operations connected by thin solid lines in FIG. 1. For example, the single-step reaction optimization platform 101 may include the material storage 110, the dispensing module 120, the reaction module 130, the preprocessing module 140, the analysis module 170, and/or the artificial intelligence device 190. However, these are only examples, and components of the single-step reaction optimization platform 101 are not limited thereto. In the single-step reaction optimization platform 101, an optimal synthesis method may be obtained as a result. For example, the optimal synthesis method may be obtained by artificial intelligence. The obtained optimal synthesis method may be applied to the scale-up purification platform 102. For example, the scale-up purification platform 102 may be a platform for performing the steps connected by thick solid lines. For example, the scale-up purification platform 102 may include the material storage 110, the dispensing module 120, the separation and purification module 150, the product storage 160, the analysis module 170, and/or the artificial intelligence device 190. However, these are only examples, and components of the scale-up purification platform 102 are not limited thereto. For example, the scale-up purification platform 102 may scale up and/or purify a result by repeating a process. The scale-up purification platform 102 may produce great amounts of reagents (e.g., materials) using the optimal synthesis method. The result of the scale-up purification platform 102 may be used again as a source of the scale-up purification platform 102 or used as a source of the single-step reaction optimization platform 101. Through such repetitive processes, a multi-step reaction may be conducted.

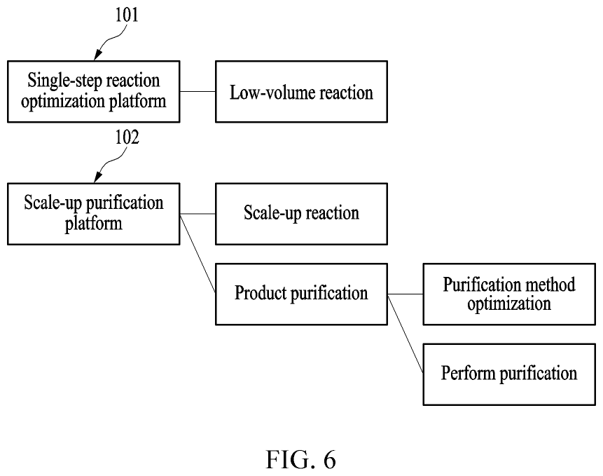

FIG. 6 is a block diagram illustrating processes of a single-step reaction optimization platform and a scale-up purification platform, according to an embodiment.

Referring to FIG. 6, the single-step reaction optimization platform 101 may perform a low-volume reaction. For example, the low-volume reaction may be a single-step reaction. The low-volume reaction may mean that a sample evaluation timing is lower than a reference value and/or a reaction volume is lower than a reference value. However, the disclosure is not limited thereto. The scale-up purification platform 102 may perform a scale-up reaction and/or product purification. For example, the scale-up reaction may be a single-step reaction and may differ from the low-volume reaction in sample evaluation timing and/or reaction volume. The reaction volume in the scale-up reaction may be larger than the reaction in the low-volume reaction of the single-step reaction optimization platform 101. The sample evaluation timing in the scale-up reaction may be larger than the sample evaluation timing in the low-volume reaction of the single-step reaction optimization platform 101. The product purification process may include purification method optimization and a purification performing process. For example, the purification performing process may be a process of purifying the product produced by the scale-up reaction. For example, as the purification performing process is repeatedly performed, the purification method may be optimized by artificial intelligence. For example, the purification performing process and the purification method optimization may be performed in parallel and combined at a predetermined point.

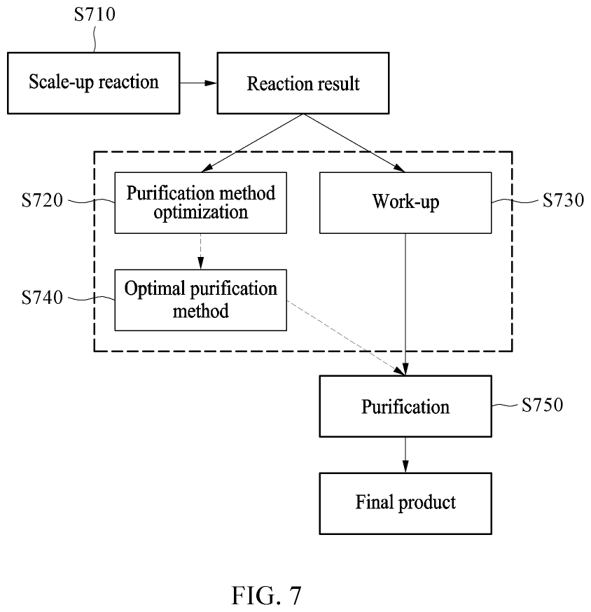

FIG. 7 is a flowchart of a scale-up purification process according to an embodiment. As illustrated in FIG. 7, a procedure performed by artificial intelligence is represented by a dashed line.

In an embodiment, the scale-up purification process according to FIG. 7 may be performed by the automated material reaction system 100 of FIG. 1. Referring to FIGS. 1, 2, and 7, a scale-up reaction may be performed by the reaction module 130 and/or the separation and purification module 150 (S710). Purification method optimization (S720) and/or a work-up process (S730) may be performed on the result of the scale-up reaction. The purification method optimization and the work-up process may be performed in parallel. As the purification method optimization is performed by artificial intelligence, an optimal purification method may be obtained (S740). For example, the artificial intelligence device 190 may obtain the optimal purification method by adjusting recipes of experiment methods. After the work-up process is performed, purification may be performed (S750). In this case, the obtained optimal purification method may be used. As purification is performed, the final product may be produced.

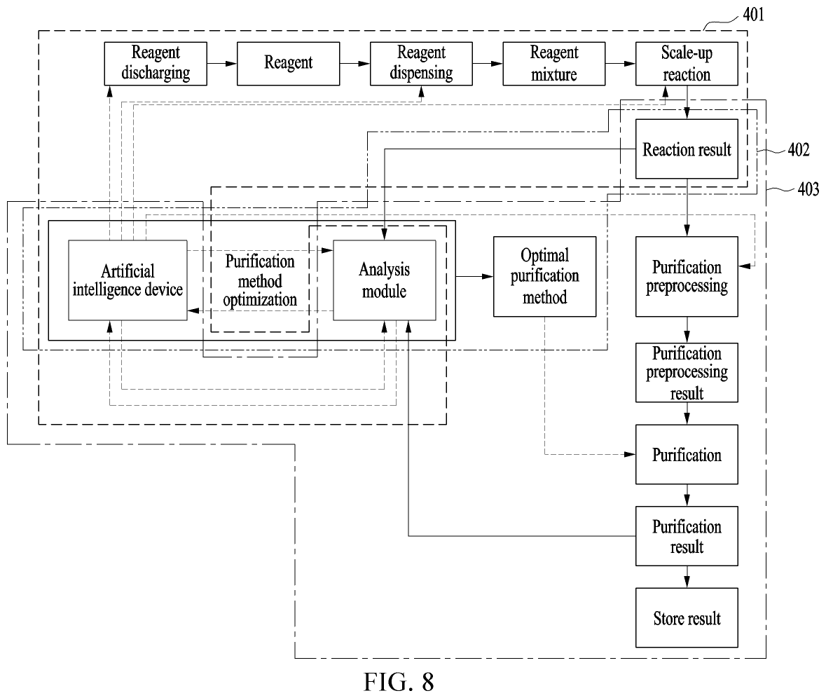

FIG. 8 is a flowchart of an operation of an automated material reaction system, according to an embodiment. As illustrated in FIG. 8, procedures performed by artificial intelligence are represented by a dashed line.

In an embodiment, referring to FIGS. 1, 2, and 8, the operation of the automated material reaction system may include a scale-up reaction 401, purification method optimization 402, and/or a separation and purification reaction 403. For example, the scale-up reaction 401, the purification method optimization 402, and the separation and purification reaction 403 may be performed sequentially and/or in parallel. For example, the purification method optimization 402 and the separation and purification method 403 may be performed in parallel and may combined into a single step at a time point at which the purification method optimization 402 is completed.

In an embodiment, in the scale-up reaction 401, a reagent stored in the material storage 110 may be discharged, the reagent is dispensed by the dispensing module 120, and then a reagent mixture may be produced. The reagent mixture may be transported to the reaction module 130, and the scale-up reaction may be performed by the reaction module 130. At least a portion of the reaction result may be aliquoted as a sample, and the aliquoted sample may be analyzed by the analysis module 170. The analysis result (e.g., yield, purity, and/or the like) may be transferred to the artificial intelligence device 190. The artificial intelligence device 190 may use the received analysis result to adjust the type of reagent used for a reaction at the reagent discharging step. The artificial intelligence device 190 may use the received analysis result and adjust reagent dispensing volume, a dispensing environment, and/or the like at the reagent dispensing step. The artificial intelligence device 190 may use the received analysis result to adjust a reaction temperature, a reaction time, and/or the like at the scale-up reaction step. The artificial intelligence device 190 may use the received analysis result to adjust an analysis evaluation method of the analysis module 170. However, this is only an example, and detailed steps of the scale-up reaction 401 and/or an operation of the artificial intelligence device 190 are not limited thereto.

In an embodiment, in the purification method optimization 402, at least a portion of the reaction result of the scale-up reaction may be aliquoted as a sample, and the aliquoted sample may be analyzed by the analysis module 170. The analysis result (e.g., a result of the evaluation of purification conditions for a sample) may be transferred to the artificial intelligence device 190. The artificial intelligence device 190 may modify the purification condition according to the analysis result, and analysis may be performed by the analysis module 170 under the modified purification condition. By repeating the processes described above, the artificial intelligence device 190 may optimize the purification method. However, this is only an example, and detailed steps of the purification method optimization 401 and/or the operation of the artificial intelligence device 190 are not limited thereto.

In an embodiment, in the separation and purification reaction 403, the reaction result (e.g., the remaining portion excluding the aliquoted sample) of the scale-up reaction may be transported to the work-up module 200, and purification preprocessing (reaction postprocessing) may be performed by the work-up module 200. A purification preprocessing method may be modified by the artificial intelligence device 190. The result of the purification preprocessing may be transported to the purification module 300 and purified by the purification module 300. Purification may be performed by the purification module 300 using the optimal purification method obtained by the artificial intelligence device 190. At least a portion of the purification result may be aliquoted as a sample, and the aliquoted sample may be transmitted to and analyzed by the analysis module 170. The remaining of the purification result excluding the aliquoted sample may be transported to and stored in the product storage 160. However, this is only an example, and detailed steps of the separation and purification reaction 403 and/or the operation of the artificial intelligence device 190 are not limited thereto.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

What is claimed is:

1. An automated material reaction system comprising:
a material storage configured to store at least one material;
a dispensing module configured to dispense, to a reaction container, the at least one material stored in the material storage;
a reaction module configured to output a first product based on a reaction based on the at least one material dispensed to the reaction container;
a separation and purification module configured to:
extract a second product from the first product output by the reaction module, and
purify the second product; and
a transport device configured to transport the second product to the dispensing module to be input as a reactant.

2. The automated material reaction system of claim 1, wherein the transport device is further configured to automatically transfer a material to be transferred between the material storage, the dispensing module, the reaction module, and the separation and purification module.

3. The automated material reaction system of claim 1, wherein the separation and purification module comprises:
a work-up module configured to separate the second product from the first product output by the reaction module; and
a purification module configured to purify the second product from a processing material of the work-up module.

4. The automated material reaction system of claim 3, wherein the work-up module comprises a filter or an evaporator.

5. The automated material reaction system of claim 4, wherein the work-up module further comprises a solvent supplier configured to supply a solvent to the filter or the evaporator.

6. The automated material reaction system of claim 3, wherein the purification module comprises:
a liquid chromatography device configured to separate the second product from the processing material processed of the work-up module; and
a fraction collector configured to fractionize the second product separated by the liquid chromatography device.

7. The automated material reaction system of claim 6, wherein the purification module further comprises an evaporator configured to vaporize a solvent from the second product fractionized by the fraction collector.

8. The automated material reaction system of claim 7, wherein the purification module further comprises a weighing machine configured to measure a weight of the second product processed by the evaporator.

9. The automated material reaction system of claim 7, wherein the purification module further comprises a solvent supplier configured to supply a solvent to the evaporator, and
wherein the purification module is further configured to supply the material processed by the evaporator back to the liquid chromatography device.

10. The automated material reaction system of claim 3, wherein each of the work-up module and the purification module comprises a capper configured to attach a cap to a container or remove the cap from the container.

11. The automated material reaction system of claim 3, wherein a material in the work-up module and the purification module is automatically transported by a sub-transport device.

12. The automated material reaction system of claim 1, further comprising:
a product storage configured to store the second product.

13. The automated material reaction system of claim 1, further comprising:
an analysis module configured to analyze the second product.

14. The automated material reaction system of claim 1, further comprising:
a preprocessing module configured to preprocess the second product produced by the reaction module.

15. The automated material reaction system of claim 1, further comprising:
an artificial intelligence device configured to control the automated material reaction system to operation in an automated manner.

16. A separation and purification module applied to an automated material reaction system, the separation and purification module comprising:
a work-up module configured to separate, from a first product, a second product produced by a reaction module; and
a purification module configured to purify the second product from a processing material of the work-up module,
wherein the work-up module comprises a filter or a first evaporator, and
wherein the purification module comprises a liquid chromatography device and a fraction collector.

17. The separation and purification module of claim 16, wherein the purification module further comprises:
a second evaporator configured to vaporize a first solvent from the second product fractionized by the fraction collector; and
a solvent supplier configured to supply a second solvent the second product processed by the second evaporator,
wherein the purification module is further configured to supply the second product back to the liquid chromatography device.

18. The separation and purification module of claim 17, wherein the purification module further comprises a weighing machine configured to measure a weight of the second product processed by the second evaporator.

19. The separation and purification module of claim 16, wherein each of the work-up module and the purification module further comprises a capper configured to attach or remove a cap to or from a container.

20. The separation and purification module of claim 16, wherein a material in the work-up module and the purification module is automatically transported by a sub-transport device.
